(19) United States
(12) Patent Application Publication
(10) Pub. No.: US 2020/0158513 A1
(43) Pub. Date: May 21, 2020

(54) INFORMATION PROCESSOR AND INFORMATION PROCESSING PROGRAM

(71) Applicant: TOYOTA JIDOSHA KABUSHIKI KAISHA, Toyota-shi (JP)

(72) Inventors: Keiko SUZUKI, Suginami-ku (JP); Ryotaro FUJIWARA, Suginami-ku (JP); Chikage KUBO, Chofu-shi (JP); Takeshi FUJIKI, Shinagawa-ku (JP); Makoto HONDA, Shinagawa-ku (JP); Ryota OKUBI, Funabashi-shi (JP)

(73) Assignee: TOYOTA JIDOSHA KABUSHIKI KAISHA, Toyota-shi (JP)

(21) Appl. No.: 16/683,752

(22) Filed: Nov. 14, 2019

(30) Foreign Application Priority Data
Nov. 15, 2018 (JP) 2018-214797

(51) Int. Cl. G01C 21/26; G06F 16/9537

(52) U.S. Cl. CPC G01C 21/26; G06F 16/9537

(57) ABSTRACT

An information processor includes: a purpose estimation portion configured to estimate a moving purpose of a user to a destination based on destination information that is information indicative of the destination set by the user; and a candidate facility proposing portion configured to determine a candidate drop-in facility where the user drops in between a departure place and the destination by use of at least the moving purpose and to propose the candidate drop-in facility thus determined to the user.

### INCORPORATION BY REFERENCE

The disclosure of Japanese Patent Application No. 2018-214797 filed on Nov. 15, 2018 including the specification, drawings and abstract is incorporated herein by reference in its entirety.

### BACKGROUND

### 1. Technical Field

The present disclosure relates to an information processor and an information processing program each of which proposes a candidate drop-in facility to a user.

### 2. Description of Related Art

Japanese Unexamined Patent Application Publication No. 2008-20334 (JP 2008-20334 A) describes a technology to provide, to a user who does not have any particular candidate drop-in site, information of a drop-in route that passes through a candidate drop-in site where the user can freely drop in. The candidate drop-in site is a place, a facility, or the like where the user may drop in between a departure place and a destination. A vehicle navigation device disclosed in JP 2008-20334 A determines a drop-in route based on information about a travel route from the departure place to the destination and information about a candidate drop-in site and displays the determined drop-in route and the travel route on a display screen.

### SUMMARY

However, in the technology described in JP 2008-20334 A, the candidate drop-in site thus provided does not consider a moving purpose of the user, and therefore, the technology has such a problem that the candidate drop-in site might not be necessarily suited for the moving purpose of the user, namely, a purpose of moving from the departure place to the destination.

The present disclosure is accomplished in view of the above problem, and an object of the present disclosure is to provide an information processor that can propose a drop-in route suited for a moving purpose of a user.

In order to achieve the above object, an information processor according to an aspect of the present disclosure includes a purpose estimation portion and a candidate facility proposing portion. The purpose estimation portion is configured to estimate a moving purpose of a user to a destination based on destination information that is information indicative of the destination set by the user. The candidate facility proposing portion is configured to determine a candidate drop-in facility where the user drops in between a departure place and the destination by use of at least the moving purpose and to propose the candidate drop-in facility thus determined to the user.

With this aspect, the user can quickly select a drop-in facility suited for the moving purpose, so that a burden put on the user due to search of the drop-in facility can be largely reduced. Further, with this configuration, a facility that cannot be found by the user without searching for a long time can be proposed in a short time without departing from the moving purpose. On this account, it is possible to provide a chance to find a facility where the user has never dropped in before, thereby making it possible to further improve enjoyment in moving to the destination.

Further, in this aspect, the purpose estimation portion may estimate the moving purpose based on the destination information included in an utterance content of the user.

With this aspect, since the destination information given by voice is used instead of the destination information manually set by the user, a burden put on the user due to search of a final destination can be largely reduced as compared to a case where the destination is manually input.

Further, in this aspect, when the moving purpose is the same as a moving purpose estimated before, the candidate facility proposing portion may propose, as the candidate drop-in facility, a drop-in facility where the user has dropped in before.

With this aspect, it is possible to propose a drop-in facility where the user is more likely to want to drop in, so that it is possible to reduce a trouble caused when the user repeatedly searches a drop-in facility and to achieve a smooth movement to a drop-in facility.

Another aspect of the present disclosure is achievable in the form of an information processing program causing a computer to execute: a purpose estimation step of estimating a moving purpose of a user to a destination based on destination information; and a candidate facility proposing step of determining a candidate drop-in facility where the user drops in between a departure place and the destination by use of at least the moving purpose and proposing the candidate drop-in facility thus determined to the user.

With the present disclosure, it is possible to yield such an effect that a drop-in route suited for a moving purpose of a user can be proposed.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a view illustrating a configuration of an information processor according to an embodiment of the present disclosure;

FIG. 2 is a view illustrating an exemplary configuration of a controlling portion illustrated in FIG. 1;

FIG. 3 is a flowchart to describe an operation of the information processor according to the embodiment of the present disclosure;

FIG. 4 is a view illustrating one example of a scheduler;

FIG. 5 is a view to describe an operation of estimating an attribute of a drop-in facility by use of action history information;

FIG. 6 is a view to describe an operation of estimating an attribute of a drop-in facility based on an utterance content;

FIG. 7 is a view to describe an estimation operation of estimating a drop-in possible facility by use of SNS information;

FIG. 8 is a view illustrating a display portion before a candidate drop-in facility is displayed;

FIG. 9 is a view illustrating the display portion after the candidate drop-in facility is displayed;

FIG. 10 is a view illustrating one example of a drop-in route; and

FIG. 11 is a view illustrating an exemplary hardware configuration to implement the information processor according to the embodiment of the present disclosure.

### DETAILED DESCRIPTION OF EMBODIMENTS

The following describes a mode for carrying out the present disclosure with reference to the drawings.

### Embodiment

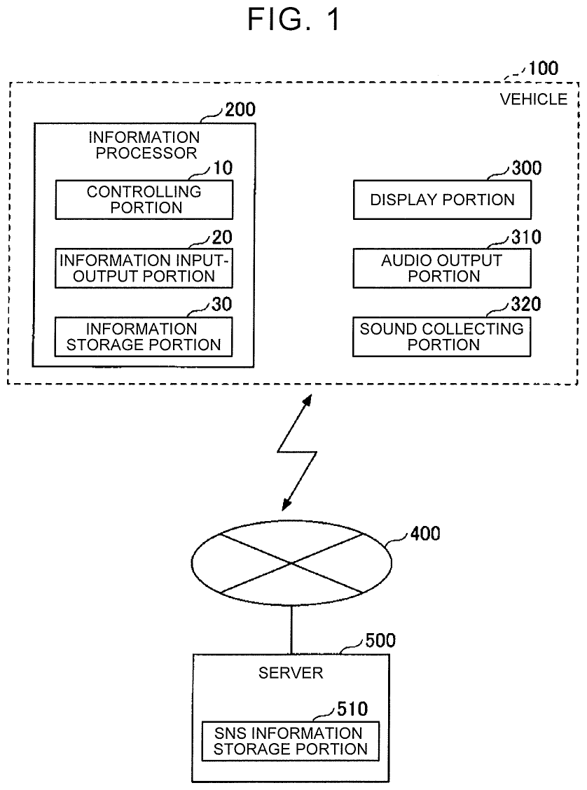

FIG. 1 is a view illustrating a configuration of an information processor according to an embodiment of the present disclosure. A vehicle 100 illustrated in FIG. 1 includes an information processor 200 according to the present embodiment, a display portion 300, an audio output portion 310, and a sound collecting portion 320. The information processor 200 is a navigation device, for example. Note that the information processor 200 is not limited to the navigation device, provided that the information processor 200 is a device that supports a movement guidance of the vehicle. The information processor 200 may be, for example, a voice recognizer configured to perform a specific operation by recognizing voice produced by an occupant in the vehicle 100. In the following description, in order to simplify the description, “vehicle 100” may be just referred to as “vehicle.” Further, “occupant” may indicate a driver of the vehicle or a companion. Further, “occupant” can be an operator of the information processor 200, and therefore, in the following description, “occupant” may be referred to as “user.” The information processor 200 can communicate with a server 500 via a communication network 400. The communication network 400 is the Internet, a network for portable terminals, and the like. The server 500 includes a social networking service (SNS) information storage portion 510. SNS information is stored in the SNS information storage portion 510. The SNS information is information about a content posted on the SNS by the user, a browsing history of the SNS that the user browses, and the like.

The information processor 200 includes a controlling portion 10, an information input-output portion 20, and an information storage portion 30. Details of the configuration of the controlling portion 10 will be described later. The information input-output portion 20 is an interface configured to transmit and receive information to and from the communication network 400 by wireless communication or wire communication and to transmit and receive information to and from the display portion 300, the audio output portion 310, and the sound collecting portion 320. For example, the information input-output portion 20 receives SNS information to be stored in the server 500 via the communication network 400, transmits information to be displayed on the display portion 300, outputs voice information to be played by the audio output portion 310, and receives voice information detected by the sound collecting portion 320. The display portion 300 is, for example, a center display to be provided in the vehicle, a meter display to be provided in the vehicle, a head mount display, a display device of a navigation device, and the like. The audio output portion 310 is a speaker configured to play, for example, a route guidance to a destination of the vehicle, music, and the like. The sound collecting portion 320 is a voice detection microphone configured to detect voice produced by the user as a vibration waveform and output a signal indicative of the detected vibration waveform as voice information. In the information storage portion 30, map data for a route guidance, information on an action history of the user, information on an utterance history of the user, and the like are stored in addition to information like the SNS information described above.

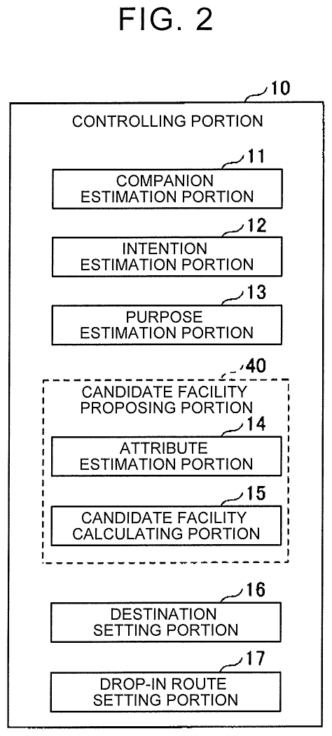

FIG. 2 is a view illustrating an exemplary configuration of the controlling portion illustrated in FIG. 1. The controlling portion 10 includes a companion estimation portion 11, an intention estimation portion 12, a purpose estimation portion 13, a candidate facility proposing portion 40, a destination setting portion 16, and a drop-in route setting portion 17.

The companion estimation portion 11 determines whether there is one user or there are a plurality of users, that is, whether there is a companion as an occupant in addition to a driver or not. The intention estimation portion 12 estimates whether the companion or the driver estimated by the companion estimation portion 11 wants to drop in a place other than the destination or not. The purpose estimation portion 13 estimates a moving purpose of the user to the destination based on destination information.

The candidate facility proposing portion 40 includes an attribute estimation portion 14 and a candidate facility calculating portion 15. The candidate facility proposing portion 40 determines a candidate drop-in facility where the user can drop in between the departure place and the destination by use of at least the moving purpose estimated by the purpose estimation portion 13 and proposes the candidate drop-in facility thus determined to the user.

The destination setting portion 16 sets a destination based on an operation or an utterance content of the user, calculates a route from a current location to the destination thus set, and displays the route on the display portion 300. The drop-in route setting portion 17 sets a drop-in facility based on an operation or an utterance content of the user from one or more candidate drop-in facilities proposed by the candidate facility proposing portion 40, calculates a route from the current location to the drop-in facility and a route from the drop-in facility to a final destination, and displays the routes on the display portion 300.

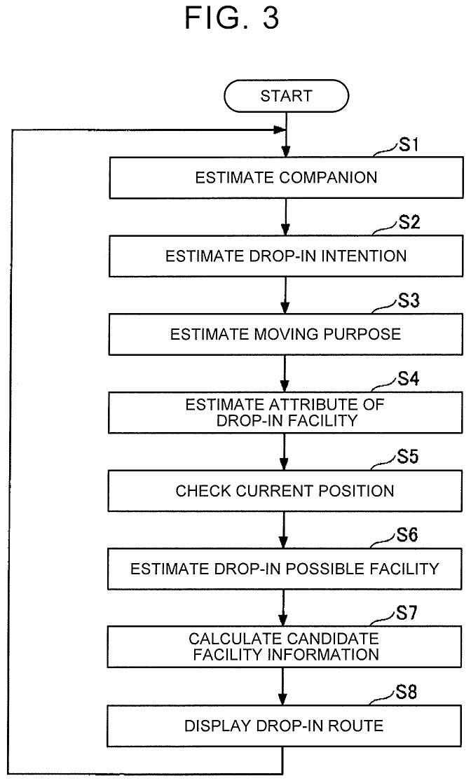

Next will be described an operation of the information processor 200 with reference to FIGS. 3 to 10. FIG. 3 is a flowchart to describe the operation of the information processor according to the embodiment of the present disclosure. A process of step S1 of the flowchart illustrated in FIG. 3 is started, for example, when the user sets a destination and the destination setting portion 16 calculates a route to the destination. The setting of the destination is performed, for example, by voice input, an operation to a touch panel, or the like.

In step S1, the companion estimation portion 11 determines whether the number of occupants is one or more, and when there are a plurality of occupants, the companion estimation portion 11 estimates that there is a companion. For example, the companion is a friend, an acquaintance, a family, and the like of the driver. The companion determination is performed by analyzing an image captured by an imager provided in the vehicle, for example. Other than this, the companion determination may be performed by use of a solid object detection sensor provided in the vehicle or may be performed by a voice dialogue. In the case of the voice dialogue, the companion estimation portion 11 reads message information stored in the information storage portion 30 in advance, converts the message information (e.g., “Do you have any companion?”) into voice information, and outputs it to the audio output portion 310. When the user responses to this question, an utterance content of the user is detected by the sound collecting portion 320, the utterance content thus detected is converted into voice information, and the voice information is input into the companion estimation portion 11. The companion estimation portion 11 analyzes a frequency component included in the voice information and determines whether there is a companion or not. By estimating the companion, it is possible to perform a moving purpose estimation (described later) without being fixed on only one opinion among the occupants. Note that a method for analyzing an utterance content from voice information is well known as disclosed in Japanese Unexamined Patent Application Publication No. 2015-211403 (JP 2015-211403 A), Japanese Unexamined Patent Application Publication No. 2018-156523 (JP 2018-156523 A), and the like, and therefore, descriptions thereof are omitted.

In step S2, the intention estimation portion 12 estimates whether or not the occupant wants to drop in at a place other than the destination. For example, the following assumes a case where the set destination is “XX hot spring.” In this case, when the utterance content of the occupant is “We are heading for a hot spring resort from now. We still have time, so shall we take a break somewhere?” or “Shall we have a lunch in a gyoza restaurant in XX district?,” the intention estimation portion 12 regards a phrase “take a brake somewhere,” “a gyoza restaurant in XX district,” or the like as a key word (information indicative of a place other than the destination), and the intention estimation portion 12 can estimate that the user wants to drop in a place other than the hot spring resort. Note that an intention estimation model is used in this intention estimation process, for example. The intention estimation model is a model learning from various example sentences and their corresponding intentions by use of a statistical technique. By use of the intention estimation model, it is possible to deal with various expressions of the user. As such, a method for estimating an intention from an utterance content of a user is well known as disclosed in Re-publication of PCT International Publication No. 2017-168637, and so on, for example.

In step S3, the purpose estimation portion 13 estimates a moving purpose of the user to the destination based on destination information. The destination information is information indicative of the destination set by the user. Examples of the destination information are an address of the destination, a facility name of the destination, a place name of the destination, a phone number of a facility as the destination, a zip code set to the facility as the destination, and the like. For example, in a case where the moving purpose is a meeting about reform of a guest house in the hot spring resort, a through-point suited for the moving purpose is a restaurant, a service area of an express highway, or the like, and a shopping mall, an amusement park, and the like are less likely to become the through-point. In the meantime, in a case where the moving purpose is to stay in a guest house in the hot spring resort, the through-point suited for the moving purpose is not limited to a restaurant, a service area of an express highway, or the like, and a shopping mall, an amusement park, and the like are also likely to become the through-point. When the purpose estimation portion 13 estimates the destination, it is possible to propose a candidate through-point suited for the moving purpose. The operation of proposing a candidate through-point is performed by the candidate facility proposing portion 40. Details of the operation of the candidate facility proposing portion 40 will be described later.

The utterance content of the user, setting destination information manually set by the user, a scheduler in which action records of the user are written down are used for the estimation of the moving purpose by the purpose estimation portion 13.

In a case where the purpose estimation portion 13 estimates the moving purpose from the utterance content, when the utterance content of the user is “We are heading for a hot spring resort from now,” for example, it is possible to estimate that the moving purpose is sightseeing or pleasure in a place where a hot spring springs out, based on “hot spring” as the key word (destination information). That is, the purpose estimation portion 13 estimates the moving purpose based on the destination information included in the utterance content of the user. By using the destination information given by voice, instead of the destination information manually set by the user, a burden put on the user due to search of a final destination is largely reduced as compared to a case where the destination is manually input. In recent years, a voice recognition technology has progressed and voice recognition accuracy has greatly improved. Accordingly, the estimation of the moving purpose by voice is more useful than estimation using the manual input, the setting destination information, or the scheduler.

In a case where the purpose estimation portion 13 estimates the moving purpose from the setting destination information, when “XX hot spring” as a name of the hot spring resort is included in the setting destination information, for example, it is possible to estimate that the moving purpose is sightseeing or pleasure in a place where a hot spring springs out. Further, in a case where the destination information set by the user includes “XX Co. Ltd.” as a company name, it is possible to estimate that the moving purpose is a business with a customer.

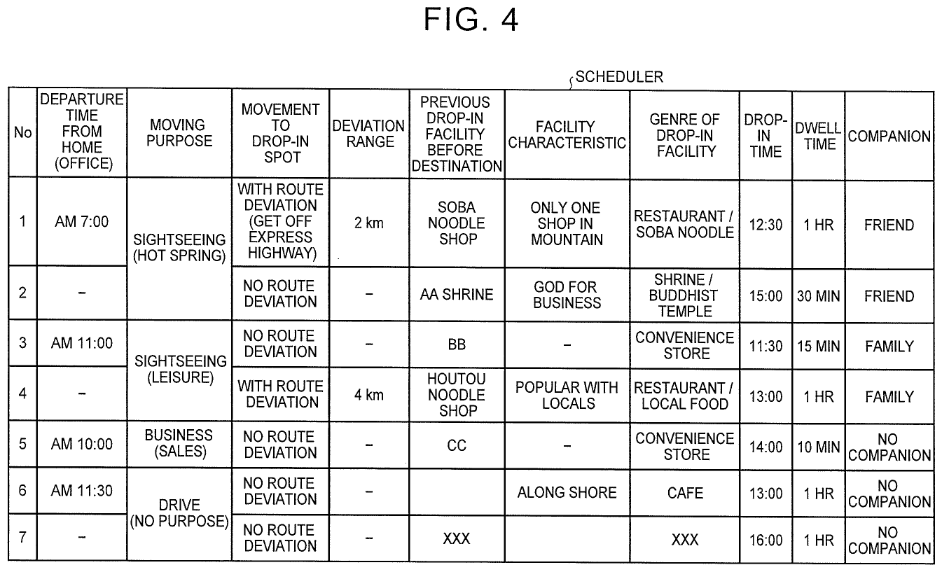

In a case where the purpose estimation portion 13 estimates the moving purpose from the scheduler, a scheduler illustrated in FIG. 4 is used. FIG. 4 is a view illustrating an example of the scheduler. The scheduler may be a history indicating that the user has moved to the destination before or may be a planned scheduler. The scheduler includes, for example, information such as a departure time, a moving purpose, a movement to a drop-in spot, a deviation range, a previous drop-in facility before a destination, a facility characteristic, a genre of a drop-in facility, a drop-in time, a dwell time, and information on whether there is a companion or not. Those pieces of information of the scheduler are stored in the information storage portion 30 or the server 500, for example, and the purpose estimation portion 13 can estimate the moving purpose by referring to the pieces of information of the scheduler.

In step S4, the attribute estimation portion 14 estimates the genre of a facility where the user wants to drop in from among one or more drop-in facilities suited for the purpose estimated in step S3, in consideration of the action history of the user. Action history information, the utterance content, and the like are used for the estimation of the attribute of the drop-in facility.

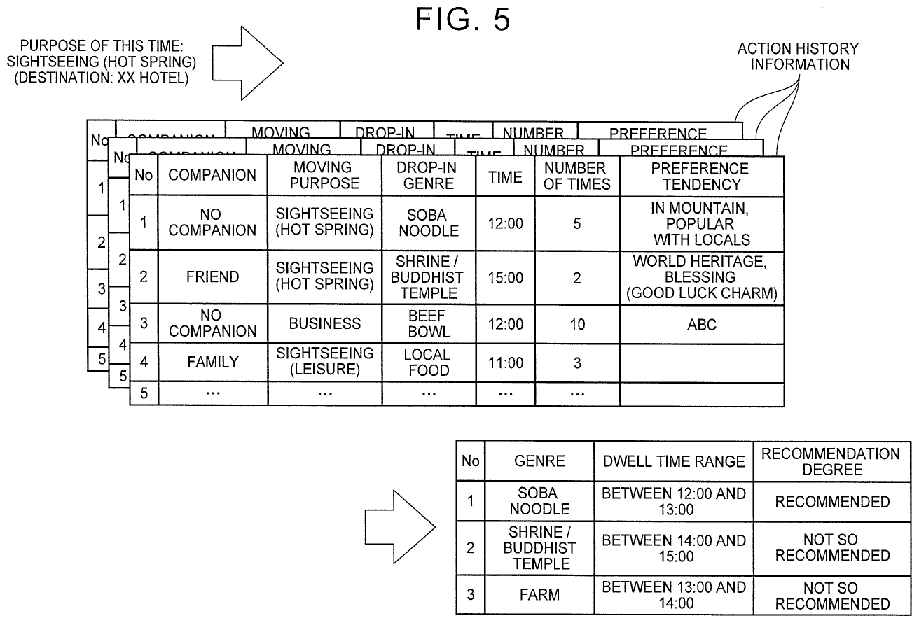

FIG. 5 is a view to describe an operation of estimating the attribute of the drop-in facility by use of the action history information. The action history information is information on the action history of the user. FIG. 5 illustrates examples of pieces of action history information of several people. These pieces of action history information are stored in the information storage portion 30 or the server 500, for example. In the action history information, a genre (an attribute of a facility) of a drop-in facility where the user has dropped in before, companion information indicative of whether the user dropped in at the facility with a companion or not, a previous drop-in time at the facility, a dwell time at the facility per once, the number of drop-in times at the facility, and a characteristic of the facility are associated with each other. Note that the companion information may be associated with information to identify a companion, e.g., information indicating that the companion is a friend, a family, or the like. For example, in a case where there is “no companion” and the moving purpose is sightseeing to “XX hotel” as results of the estimations in step S1 and step S3, the attribute estimation portion 14 refers to the companion information and the information of the moving purpose in the action history information in consideration of a current time, and proposes a plurality of genres of facilities corresponding to the estimation results in step S1 and step S3. At this time, the attribute estimation portion 14 proposes drop-in genres by associating respective pieces of information (information expressed as “RECOMMENDATION”) indicative of a recommendation degree as illustrated on the right side in FIG. 5 with the genres of the facilities.

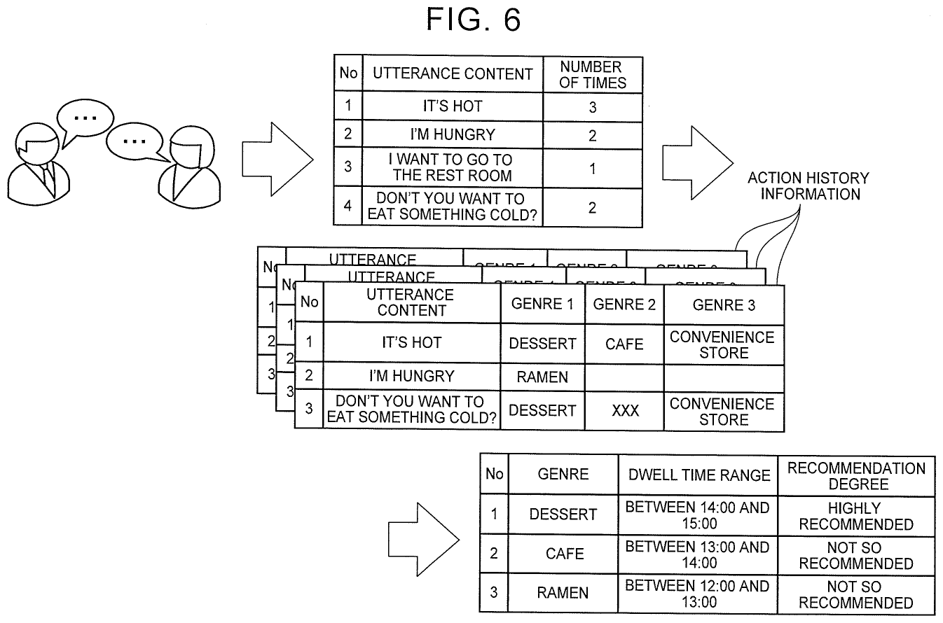

FIG. 6 is a view to describe an operation of estimating the attribute of the drop-in facility based on the utterance content. When the utterance content is, for example, “It's hot,” “I'm hungry,” “I want to go to the restroom,” “Don't you want to eat something cold?,” or the like, the attribute estimation portion 14 learns these utterance contents and the number of utterance times and stores information in which each utterance content is associated with the number of utterance times of the utterance content, in the information storage portion 30 or the server 500, for example, as utterance history information. FIG. 6 illustrates an example of the utterance history information. The attribute estimation portion 14 checks the action history information illustrated in FIG. 6 for a genre of a facility corresponding to the utterance content in the utterance history information thus stored. The action history information is stored in the information storage portion 30 illustrated in FIG. 1. In the action history information, an utterance content is associated with genres “1” to “3” of a plurality of facilities where the user dropped in when the user made the utterance. When an actual utterance content corresponds to any of the utterance contents stored in the action history information, the attribute estimation portion 14 estimates a genre corresponding to the utterance content. In the example of FIG. 6, a genre of a facility estimated for the utterance content “IT'S HOT” is “DESSERT,” “CAFE,” “CONVENIENCE STORE,” and the like. Further, a genre of a facility estimated for the utterance content “I'M HUNGRY” is “RAMEN.” The attribute estimation portion 14 estimates, as a drop-in facility, a genre of a facility with a relatively large number of utterance times from among the genres of the facilities estimated for the utterance content.

As such, the attribute estimation portion 14 estimates the genre of the facility where the user wants to drop in, in consideration of the action history of the user. That is, when the moving purpose is the same as a moving purpose estimated before, the candidate facility proposing portion 40 including the attribute estimation portion 14 proposes the drop-in facility where the user has dropped in before, as the candidate drop-in facility this time. Hereby, it is possible to propose a drop-in facility where the user is more likely to want to drop in, so that it is possible to reduce a trouble caused when the user repeatedly searches a drop-in facility and to achieve a smooth movement to a drop-in facility.

In step S5, the candidate facility calculating portion 15 checks a current position of the vehicle. This is because the current position of the vehicle is taken into consideration when a facility corresponding to the genre estimated in the attribute estimation portion 14 is proposed as the drop-in facility. A global positioning system (GPS) signal is used for the current position of the vehicle, for example.

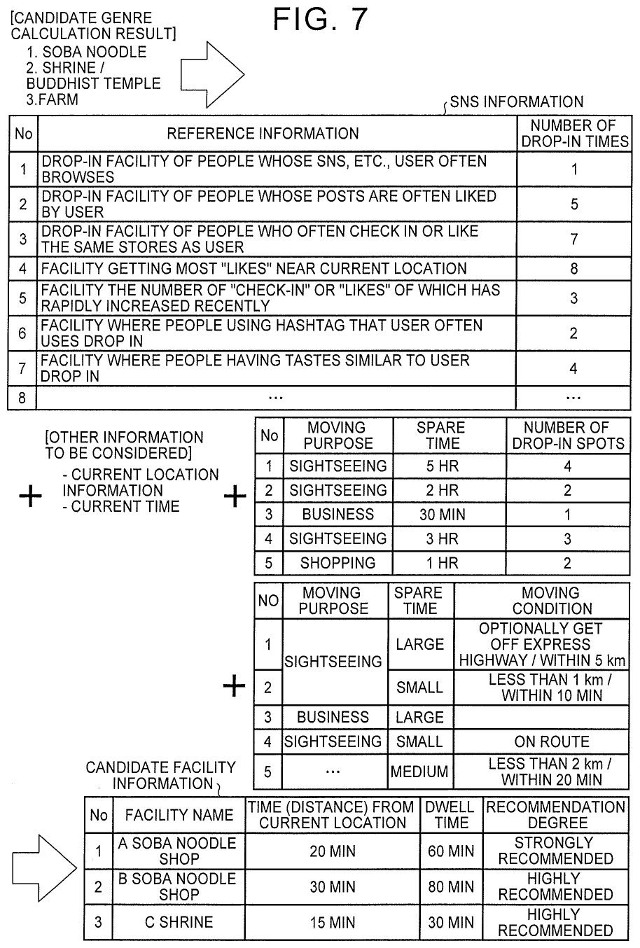

In step S6, the candidate facility calculating portion 15 estimates a drop-in possible facility from facilities corresponding to the genres estimated in step S4. In this estimation process, SNS information, current position information, a current time, a moving purpose, a spare time to arrival, a movement condition, and the like are taken into consideration. The following describes an estimation operation of estimating a drop-in possible facility with reference to FIG. 7.

FIG. 7 is a view to describe the estimation operation of estimating a drop-in possible facility by use of SNS information. For example, in a case where the facilities estimated in step S4 are “1. SOBA NOODLE,” “2. SHRINE/BUDDHIST TEMPLE,” and “3. FARM,” the candidate facility calculating portion 15 refers to SNS information illustrated in FIG. 7. In the SNS information, reference information and the number of drop-in times are recorded in association with each other. Examples of the reference information are “DROP-IN FACILITY OF PEOPLE WHOSE SNS, ETC., IS OFTEN BROWSED BY USER,” “DROP-IN FACILITY OF PEOPLE WHOSE POSTS ARE OFTEN LIKED BY USER,” “DROP-IN FACILITY OF PEOPLE WHO OFTEN CHECK IN OR LIKE THE SAME STORES AS USER,” “FACILITY GETTING MOST “LIKES” NEAR CURRENT LOCATION,” “FACILITY THE NUMBER OF “CHECK-IN” OR “LIKES” OF WHICH HAS RAPIDLY INCREASED RECENTLY,” “FACILITY WHERE PEOPLE USING HASHTAG OFTEN USED BY USER DROP IN,” “FACILITY WHERE PEOPLE HAVING TASTES SIMILAR TO USER DROP IN,” and so on. The SNS information may be SNS information stored in the server 500 illustrated in FIG. 1 or may be SNS information stored in the information storage portion 30 by in the information processor 200 by referring to the server 500. The candidate facility calculating portion 15 compares the estimated genre with the SNS information and determines whether or not a facility corresponding to the estimated genre “1. SOBA NOODLE” corresponds to a facility described in the field of “REFERENCE INFORMATION.” When there is a facility corresponding to the estimated genre, the candidate facility calculating portion 15 refers to the number of drop-in times at the facility. It may be said that, as the facility has a larger number of drop-in times, the facility is closer to a facility where the user wants to drop in.

Further, the candidate facility calculating portion 15 estimates a drop-in possible facility in consideration of current location information, a current time, a spare time, and the like. The current location information indicates a current position, a traffic volume around the current position, weather around the current position, and the like. The spare time is a time when the user can stay in the drop-in facility. For example, when an arrival expectation time if the user moves directly from the current position to the destination is 13:00 and a target arrival time to the destination is 15:00, there are two hours as a free time. For example, in a case where the moving purpose is trip, the target arrival time is a time when the user can check in a guest house. In a case where the moving purpose is business, the target arrival time is a start time of a meeting with a customer. A time difference obtained by subtracting, from the free time, a time to be obtained when the user moves a route passing through the drop-in facility is the spare time. The candidate facility calculating portion 15 calculates such a spare time per genre corresponding to the moving purpose. Further, the candidate facility calculating portion 15 calculates the number of drop-in facilities (the number of drop-in spots) corresponding to the spare time. By calculating the spare time, it is possible to estimate a movable range of the user, and the number of drop-in possible facilities can be estimated from the movable range.

Further, for example, the spare time changes depending on a type of a road accessing the drop-in facility. On this account, the candidate facility calculating portion 15 employs types of roads such as an express highway, an open road, and a bypass road as a movement condition and calculates the spare time by calculating respective mean running speeds to be obtained when those roads are used. Note that the spare time may be calculated in consideration of a traffic condition such as VICS (registered trademark) other than the types of roads.

The candidate facility calculating portion 15 considers the spare time and so on with respect to the facility corresponding to the genre estimated by the attribute estimation portion 14 and calculates candidate facility information (see the right side in FIG. 7) (step S7). The candidate facility information is information in which a name of the facility corresponding to the genre estimated by the attribute estimation portion 14 is associated with a dwell time in the facility, a recommendation degree, and so on, for example. The candidate facility information is stored in the information storage portion 30 or the server 500.

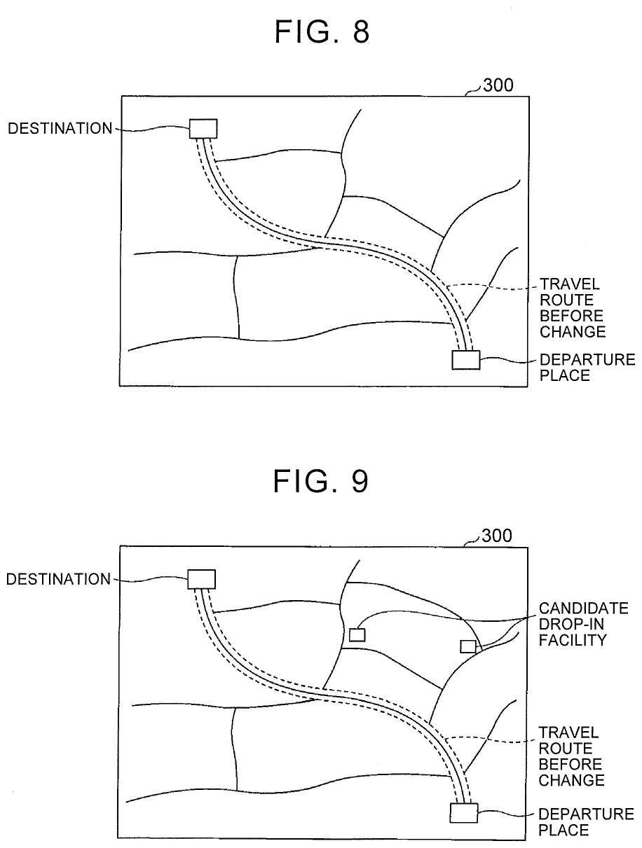

The candidate facility calculating portion 15 produces display information to cause the display portion 300 to display one or more candidate drop-in facilities based on the candidate facility information and outputs it to the display portion 300. FIG. 8 is a view illustrating the display portion before the candidate drop-in facility is displayed. The departure place, the destination, the travel route from the departure place to the destination, and the like are displayed on the display portion 300 before the candidate drop-in facility is displayed. FIG. 9 is a view illustrating the display portion after the candidate drop-in facility is displayed. A plurality of candidate drop-in facilities is displayed on the display portion 300 as illustrated in FIG. 9.

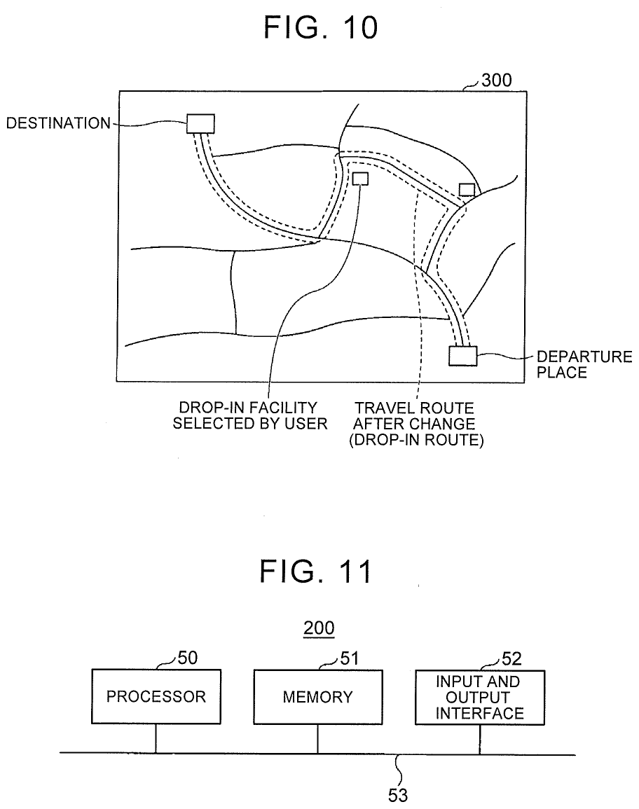

In a case where any given facility is selected by an operation on the touch panel from among the candidate drop-in facilities displayed on the display portion 300, for example, the display portion 300 produces identification information to identify the selected facility and outputs it to the drop-in route setting portion 17. The drop-in route setting portion 17 that has received the identification information reads a facility corresponding to the identification information from the information storage portion 30. The drop-in route setting portion 17 calculates a route from the current location to the facility based on the facility information thus read and displays the route on the display portion 300 as a drop-in route, as illustrated in FIG. 10 (step S8). FIG. 10 is a view illustrating an example of the drop-in route.

Note that the drop-in route can be displayed when the facility is selected by voice input other than the touch operation. More specifically, in a case where a name of any given facility is selected from among the candidate drop-in facilities displayed on the display portion 300 by voice input of “convenience store” or the like, the sound collecting portion 320 detects the voice and outputs the detected voice information to the drop-in route setting portion 17. The drop-in route setting portion 17 analyzes a frequency component included in the voice information thus received and reads a facility corresponding to the utterance content (facility name) from the information storage portion 30. The drop-in route setting portion 17 calculates a route from the current location to the facility based on the facility information thus read and displays the route on the display portion 300 as the drop-in route. A method for specifying information corresponding to an utterance content is well known as disclosed in Japanese Unexamined Patent Application Publication No. 2017-126861 (JP 2017-126861 A) and the like, and therefore, descriptions thereof are omitted.

Note that a process of step S6 performed by the candidate facility calculating portion 15 is performable when the target arrival time to the final destination is not determined, other than when the arrival time to the final destination is determined. For example, the target arrival time to the final destination can be estimated by use of information in which past actions of the user are written down. By use of the target arrival time thus estimated, the spare time as described above can be estimated. Thus, it is possible to estimate a movable range of the user. Further, even in a case where a message “I want to arrive at XX hotel at around XX o'clock” is input by voice input, the candidate facility calculating portion 15 can estimate what time the user wants to arrive at the final destination by analyzing this voice information.

Further, even in a case where the user wants to drop in at a facility around the final destination after the user arrives at the final destination earlier than the target arrival time, the candidate facility calculating portion 15 can estimate the candidate drop-in facility. For example, in a case where the use utters a voice “Is there any place where I can experience foot-bathing near here?” after the user has arrived at the final destination, the candidate facility calculating portion 15 analyzes this voice information and estimates a facility around the final destination based on the keywords “near here” and “foot-bathing.” In this estimation process, the SNS information, the spare time, and the like are taken into consideration, for example.

Further, the process by the candidate facility calculating portion 15 is also performable both in an outward path and in a return path. For example, in a case where the moving purpose is trip, the final destination is an accommodation facility in a route (outward path) from a home to the accommodation facility, and the final destination is the home in a route (return path) from the accommodation facility to the home. On this account, it is possible to propose the candidate drop-in facility after the outward path is set, and it is also possible to propose the candidate drop-in facility after the return path is set.

Further, a timing when the candidate drop-in facility is proposed may be before the vehicle moves or may be while the vehicle is moving. In a case where the vehicle is moving, a traveling time to the drop-in facility changes in real time depending on the current position of the vehicle, a traffic condition around the vehicle, a type of a road where the vehicle runs, and the like. On this account, while the candidate facility calculating portion 15 updates those pieces of information sequentially by a given cycle, the candidate facility calculating portion 15 proposes a latest candidate drop-in facility.

FIG. 11 is an exemplary hardware configuration to implement the information processor according to the embodiment of the present disclosure. The information processor 200 can be implemented by a central processing unit (CPU), a processor 50 such as a system large scale integration (LSI), a memory 51 constituted by a random access memory (RAM), a read only memory (ROM), and the like, and an input and output interface 52. Note that the processor 50 may be a computing unit such as a microcomputer or a digital signal processor (DSP). The processor 50, the memory 51, and the input and output interface 52 are connected to a bus 53 so that they can mutually transmit and receive information via the bus 53. The input and output interface 52 transmits and receives information to and from the display portion 300, the audio output portion 310, the sound collecting portion 320, and the communication network 400. In a case where the information processor 200 is implemented, a program for the information processor 200 is stored in the memory 51, and the processor 50 executes the program, so that a function of the controlling portion 10 is implemented. The program for the information processor 200 is an information processing program causing a computer to execute a target estimation step of estimating the moving purpose of the user to the destination based on destination information, and a candidate facility proposing step. The candidate facility proposing step is a process of determining a candidate drop-in facility between the departure place and the destination by use of at least the moving purpose and proposing the candidate drop-in facility thus determined to the user.

As described above, the information processor 200 according to the embodiment of the present disclosure includes: a purpose estimation portion configured to estimate a moving purpose of a user to a destination based on destination information; and a candidate facility proposing portion configured to determine a candidate drop-in facility where the user drops in between a departure place and the destination by use of at least the moving purpose estimated by the purpose estimation portion and to propose the candidate drop-in facility thus determined to the user. With this configuration, the user can quickly select a drop-in facility suited for the moving purpose, so that a burden put on the user due to search of the drop-in facility can be largely reduced. Further, with this configuration, a facility that cannot be found by the user without searching for a long time can be proposed in a short time without departing from the moving purpose. On this account, it is possible to provide a chance to find a facility where the user has never dropped in before, thereby making it possible to further improve enjoyment in moving to the destination.

Note that the present embodiment deals with an example in which the information processor 200 is provided in the vehicle, but the function of the information processor 200 is also applicable to the server 500, a smartphone, and the like.

The configuration described in the above embodiment shows an example of the content of the present disclosure. The configuration can be combined with another publicly known technique, and the configuration can be partially omitted or modified without departing from the gist of the present disclosure.

What is claimed is:

1. An information processor comprising:
a purpose estimation portion configured to estimate a moving purpose of a user to a destination based on destination information that is information indicative of the destination set by the user; and
a candidate facility proposing portion configured to determine a candidate drop-in facility where the user drops in between a departure place and the destination by use of at least the moving purpose and to propose the candidate drop-in facility thus determined to the user.

2. The information processor according to claim 1, wherein the purpose estimation portion estimates the moving purpose based on the destination information included in an utterance content of the user.

3. The information processor according to claim 1, wherein, when the moving purpose is the same as a moving purpose estimated before, the candidate facility proposing portion proposes, as the candidate drop-in facility, a drop-in facility where the user has dropped in before.

4. An information processing program causing a computer to execute:
a purpose estimation step of estimating a moving purpose of a user to a destination based on destination information; and
a candidate facility proposing step of determining a candidate drop-in facility where the user drops in between a departure place and the destination by use of at least the moving purpose and proposing the candidate drop-in facility thus determined to the user.
